(19) United States
(12) Patent Application Publication
(10) Pub. No.: US 2007/0120460 A1
(43) Pub. Date: May 31, 2007

(54) Image display device

(76) Inventors: Hae-Su Youn, Yongin-si (KR); Hideki Miyazaki, Yongin-si (KR); Won-Bok Lee, Yongin-si (KR); Hyun-Chul Ji, Yongin-si (KR); Hyuck-Keun Oh, Yongin-si (KR); Seung-Hee Jeong, Yongin-si (KR); Soon-Cheol Shin, Yongin-si (KR); Bong-Kyung Suk, Yongin-si (KR)

Correspondence Address: CHRISTIE, PARKER & HALE, LLP, PO BOX 7068, PASADENA, CA, 91109-7068, US

(21) Appl. No.: 11/606,662

(22) Filed: Nov. 29, 2006

(30) Foreign Application Priority Data
Nov. 30, 2005 (KR) 10-2005-0115659
Apr. 28, 2006 (KR) 10-2006-0038580

(51) Int. Cl. H01J 1/62

(52) U.S. Cl. 313/495

(57) ABSTRACT

An image display device includes a vacuum vessel having first and second substrates facing each other, and a sealing member disposed between the first and the second substrates. An electron emission unit is provided on a surface of the first substrate facing the second substrate, and a light emission unit is provided on a surface of the second substrate facing the first substrate. Anode leads are drawn from the light emission unit to one-side of the periphery of the second substrate, extending over the inside and the outside of the sealing member. An anti-static layer is provided at the boundary area between the anode lead and the sealing member within the vacuum vessel.

### CROSS-REFERENCES TO RELATED APPLICATIONS

This application claims priority to and the benefit of Korean Patent Applications Nos. 10-2005-0115659 filed on Nov. 30, 2005 and 10-2006-0038580 field on Apr. 28, 2006 in the Korean Intellectual Property Office, the entire content of which is incorporated herein by reference.

### BACKGROUND OF THE INVENTION

1. Field of the Invention

The present invention relates to an image display device, and in particular, to an image display device which inhibits electric charging in a vacuum vessel to prevent arc discharging.

2. Description of Related Art

Electron emission devices using a cold cathode are generally known as a field emission array (FEA) type, a surface-conduction emission (SCE) type, a metal-insulator-metal (MIM) type, and a metal-insulator-semiconductor (MIS) type.

Although the electron emission devices are differentiated in specific structure depending upon the type thereof, they basically include electron emission regions provided on a substrate, and driving electrodes for controlling the on/off and amount of electron emission. Such an electron emission device may be used as a light source such as a backlight unit, or as an electron emission structure of an image display device.

In the typical structure of the image display device using electron emission elements, electron emission regions and driving electrodes are formed on a first substrate, and phosphor layers are formed on a surface of a second substrate facing the first substrate together with an anode electrode to provide for the phosphor layers being at a high potential state.

The first and the second substrates are sealed to each other at the peripheries thereof by a sealing member, thereby constructing a vacuum vessel. The anode electrode is connected to an external power source through anode lead lines formed on the second substrate and extending over the inside and the outside of the sealing member to receive a high voltage needed for accelerating the electron beams.

With the image display device, electrons are emitted from the electron emission regions due to the operation of the electron emission regions and the driving electrodes. The electrons are accelerated toward the second substrate, and collide against the phosphor layers, followed by the excitation of the phosphor layers and the emission of visible rays.

However, after the excitation of the phosphor layers, the electrons do not quickly flow out, but accumulate at the interior of the vacuum vessel to thereby provide electric charging.

The electric charging induces arc discharging, which damages the electron emission structure and lowers the vacuum degree, thereby deteriorating the product characteristics. Furthermore, in the conventional image display device, the high voltage applied to the anode electrode needs to be confined to a predetermined degree in view of the arc discharging, and, as such, it becomes difficult to heighten the screen luminance.

### SUMMARY OF THE INVENTION

In accordance with the present invention, an image display device is provided which prevents electric charging in a vacuum vessel and arc discharging resulting therefrom, while heightening the screen luminance.

According to one aspect of the present invention, an image display device includes a vacuum vessel with first and second substrates facing each other, and a sealing member disposed between the first and the second substrates to seal the substrates to each other. The vacuum vessel has an active area internal to the sealing member, and a non-active area surrounding the active area internal to the sealing member. An electron emission unit is provided at the active area of the first substrate. A light emission unit is provided at the active area of the second substrate to emit visible rays due to the electrons emitted from the electron emission unit. An anti-static layer is provided on at least a part of the non-active surface area.

Anode leads may be drawn from the light emission unit to one-side of the periphery of the second substrate, and extending over the inside and the outside of the sealing member. The anti-static layer may cover the boundary area between the anode lead and the inner wall of the sealing member.

The anti-static layer may be formed in the shape of a band having a predetermined width, and covers the surface portion of the anode lead placed internal to the sealing member around the boundary area, and a part of the inner wall of the sealing member. The anti-static layer may have a width larger than the width of the anode lead.

Alternatively, the anti-static layer may be formed on the entire non-active surface area of the first substrate, the entire non-active surface area of the second substrate including the anode lead lines, and the entire inner wall of the sealing member.

The anti-static layer may be formed of a material having a secondary electron emission coefficient of about 1, for example, chromium oxide Cr₂O₃. Alternatively, the anti-static layer may be formed of metallic oxide based on a metallic material selected from the group consisting of Cr, Mn, Fe, Co, Y, Ni, Cu, Zr, Nb, Mo, Hf, Ta, W, and Ru, or a combination thereof.

The vacuum vessel may further have a reinforcing member provided at the rear of the first substrate to form an internal space together with the first substrate, and the first substrate may have at least one through-hole within the vacuum vessel. Alternatively, the vacuum vessel may further have a reinforcing substrate attached to the rear of the first substrate with a thickness larger than the thickness of the first substrate. With the vacuum vessel, any spacers are not provided between the first and the second substrates.

### BRIEF DESCRIPTION OF THE DRAWINGS

FIG. 1 is an exploded perspective view of an image display device according to a first embodiment of the present invention.

FIG. 2 is a bottom view of a second substrate and a sealing member of the image display device shown in FIG. 1.

FIG. 3 is a partial sectional view of the image display device according to the first embodiment of the present invention.

FIG. 4 is a partial sectional view of an image display device according to a second embodiment of the present invention.

FIG. 5 is a bottom view of a second substrate and a sealing member of the image display device according to the second embodiment of the present invention.

FIG. 6 is a partial sectional view of the image display device according to the first embodiment of the present invention, applied to the FEA type display device.

FIG. 7 is a cross sectional view of an image display device according to a third embodiment of the present invention.

FIG. 8 is a cross sectional view of an image display device according to a fourth embodiment of the present invention.

### DETAILED DESCRIPTION

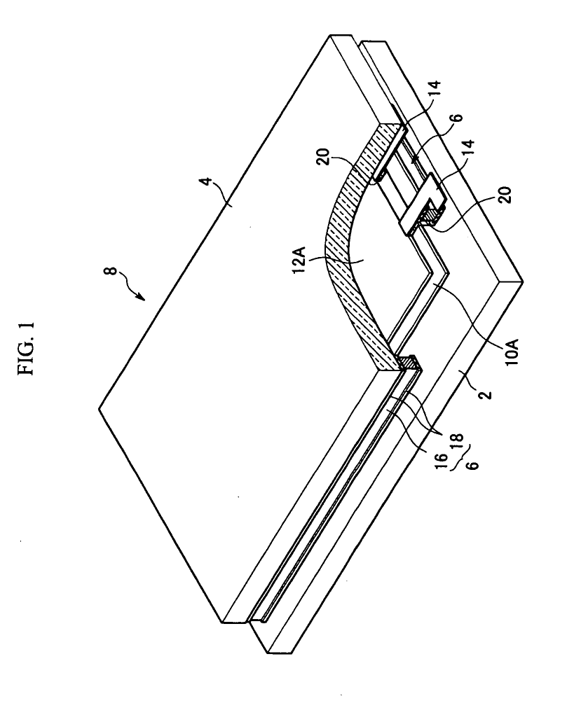

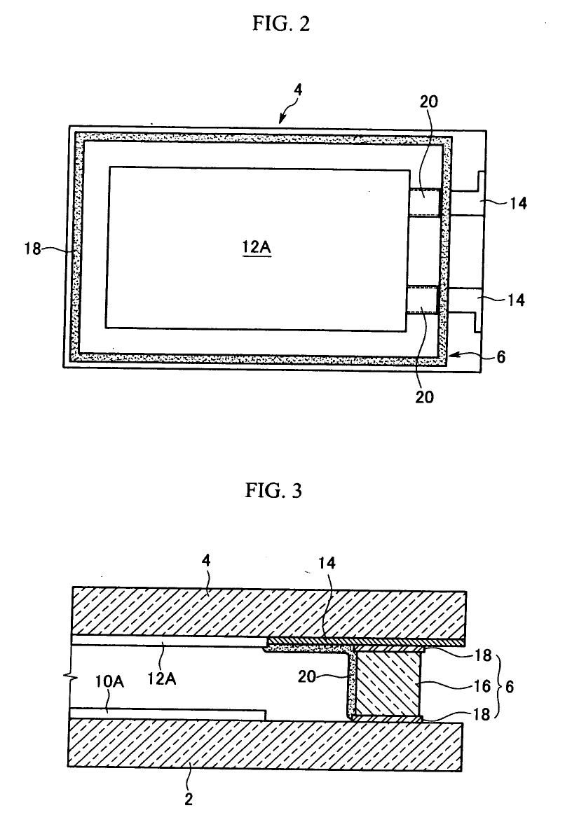

As shown in FIGS. 1, 2 and 3, an image display device according to a first embodiment of the present invention includes first and second substrates 2, 4 facing each other in parallel at a predetermined distance. A sealing member 6 is provided at the peripheries of the first and the second substrates 2, 4 to seal them to each other. The first substrate 2, the second substrate 4 and the sealing member 6 form vacuum vessel 8.

Within the periphery of the sealing member 6, the first and the second substrate 2, 4 includes an active area and a non-active area surrounding the active area. An electron emission unit 10A is provided at the active area of the first substrate 2 to emit electrons toward the second substrate 4. A light emission unit 12A is provided at the active area of the second substrate 4 to emit visible rays due to the electrons, thereby emitting light and displaying desired images.

The electron emission unit 10A has electron emission regions, driving electrodes for controlling the on/off and amount of electron emission from the electron emission regions, and additionally, an electrode for correcting the trajectories of electron beams. The light emission unit 12A has phosphor layers, such as red, green and blue phosphor layers, and an anode electrode for keeping the phosphor layers at a high potential state.

The light emission unit 12A includes anode leads 14 for applying a voltage to the anode electrode. The anode leads 14 are drawn from the light emission unit 12A to one-side of the periphery of the second substrate 4, and extended over the internal non-active area of the sealing member 6 and the outside thereof.

The anode leads 14 are provided at the one-side area of the second substrate 4 as a pair. As direct current (DC) voltages of several hundreds to several thousands volts are applied to the anode leads 14, they have a width large enough to reduce the internal resistance. The anode leads 14 may be formed of a metallic material having an high electrical conductivity, for example, with chromium Cr.

In the present embodiment, the sealing member 6 has a support frame 16 for spacing the first and the second substrates 2, 4 from each other at a predetermined distance, and adhesive layers 18 disposed between the first substrate 2 and the support frame 16 and between the second substrate 4 and the support frame 16 to adhere the two substrates to the support frame 16.

The support frame 16 is formed of glass, ceramic, a glass-ceramic mixture, a reinforced glass, or a ceramic-reinforced glass mixture, and in an exemplary embodiment has the same thermal expansion coefficient as the first and the second substrates 2, 4, or similar thereto. The adhesive layer 18 is mainly formed by a glass frit to adhere the first and the second substrates 2, 4 to the support frame 16 while preventing the vacuum leakage.

Alternatively, the sealing member 6 may be formed only with a frit bar, with the support frame being omitted.

In the present embodiment, an anti-static layer 20 is formed at the internal non-active area of the vacuum vessel 8 to inhibit the accumulation of charges. The anti-static layer 20 covers the boundary area between the anode leads 14 and the inner wall of the sealing member 6 contacting each other.

Specifically, the anti-static layer 20 may be formed in the shape of a band having a predetermined width. The anti-static layer 20 covers the portion of the anode lead 14 placed internal to the sealing member 6, the boundary between the anode lead 14 and the inner wall of the sealing member 6, and the inner wall of the sealing member 6. In order to effectively inhibit the electric charging, the anti-static layer 20 may have a width larger than that of the anode lead 14 internal to the sealing member 6.

In the present embodiment, the anti-static layers 20 is provided in pairs, corresponding to the number of anode leads 14.

The anti-static layer 20 inhibits the electric charging intensively made at the contact area between the high voltage conductor-based anode lead 14 and the insulator-based sealing member 6, that is, at the boundary area between the anode lead 14 and the inner wall of the sealing member 6 contacting each other.

The anti-static layer 20 is formed of a material having a secondary electron emission coefficient of about 1 where the electric charging is not made, for example, with chromium oxide Cr₂O₃. The anti-static layer 20 may be easily formed by screen-printing or spray-coating a paste or liquid mixture containing chromium oxide.

Alternatively, the anti-static layer 20 may be formed of metallic oxide based on a metallic material selected from Cr, Mn, Co, Y, Ni, Zr, Nb, Mo, Hf, Ta, W, Ru, or a combination thereof. In this case, the anti-static layer 20 may be easily formed through sputtering.

Accordingly, with the image display device according to the present embodiment, the electric charging intensively made in the vacuum vessel is inhibited by way of the anti-static layer 20, thereby preventing the possible arc discharging due to the electric charging. As a result, the electron emission unit 10A and the light emission unit 12A are effectively prevented from being broken, while the vacuum degree of the vacuum vessel is sustained constantly. Even when a high voltage of about 10 kV or more is applied to the anode electrode 38, arc discharging is prevented and screen luminance is enhanced pursuant to the elevation in anode voltage.

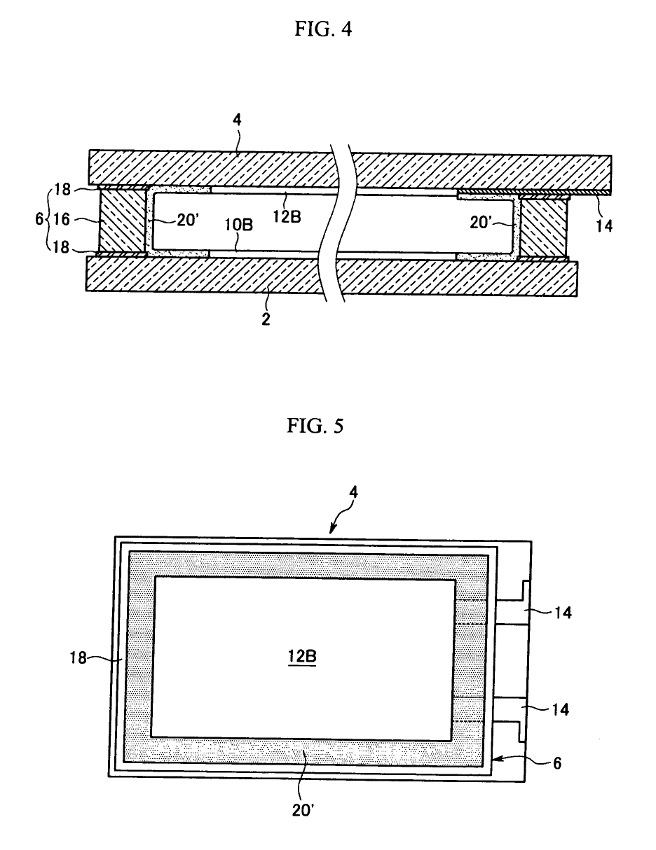

As shown in FIGS. 4 and 5, an image display device according to a second embodiment of the present invention basically has the same structure as that related to the first embodiment while the anti-static layer further enlarged in area.

In the present embodiment, the anti-static layer 20′ is formed on the entire non-active surface area of the first substrate 2 directly exposed to the vacuum atmosphere, the entire non-active surface area of the second substrate 4 including the anode lead 14, and the entire inner wall of the sealing member 6. The anti-static layer 20′ is formed of the same material as that related to the previous embodiment.

The anti-static layer 20′ inhibits the accumulation of charges on the surface of the dielectric glass-based first and second substrates 2, 4 and the sealing member 6, thereby preventing the arc discharging in the vacuum vessel due to the accumulated charges.

In the drawings, the reference numeral 10B indicates an electron emission unit, 12B a light emission unit, and like reference numerals are used to indicate other structural components.

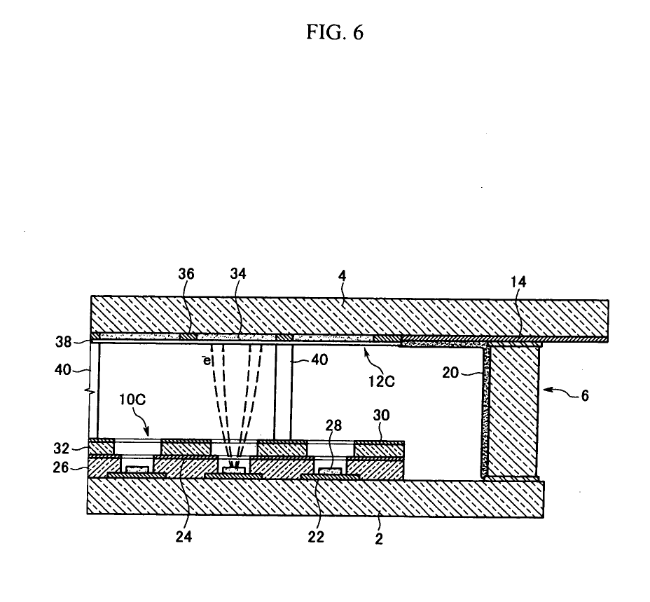

The image display devices according to the first and the second embodiments may be an FEA type, an SCE type, an MIM type or an MIS type. The structure of the FEA type image display device will be briefly explained with reference to FIG. 6.

As shown in FIG. 6, the electron emission unit 10C provided at the first substrate 2 includes cathode and gate electrodes 22, 24 as the driving electrodes, a first insulating layer 26 disposed between the cathode and the gate electrodes 22, 24 to insulate them from each other, electron emission regions 28 electrically connected to the cathode electrodes 22, a focusing electrode 30 placed over the gate electrodes 24, and a second insulating layer 32 disposed between the gate electrode 24 and the focusing electrode 30 to insulate them from each other.

The electron emission regions 28 are formed of a material emitting electrons when an electric field is applied thereto under a vacuum atmosphere, such as a carbonaceous material and a nanometer-sized material. Alternatively, the electron emission regions may be formed of a sharp-pointed tip structure based upon molybdenum Mo or silicon Si.

The light emission unit 12C provided at the second substrate 4 includes red, green and blue phosphor layers 34, black layers 36 disposed between the respective phosphor layers 34 to enhance the screen contrast, and an anode electrode 38 formed on the phosphor layers 34 and the black layers 36. The anode electrode 38 may be formed of a metallic material such as aluminum Al. The anode electrode 38 reflects the visible rays radiated from the phosphor layers 34 to the first substrate 2 toward the second substrate 4 to thereby enhance the screen luminance.

Spacers 40 are arranged between the first and the second substrates 2, 4 to endure the pressure applied to the vacuum vessel and space them from each other at a predetermined distance. The spacers 40 are located corresponding to the black layers 36 such that they do not intrude upon the area of the phosphor layers 34.

With the above structure, one of the cathode and the gate electrodes 22, 24 receives a scan driving voltage, and the other electrode receives a data driving voltage. The focusing electrode 30 receives a voltage needed for focusing the electron beams, for example, 0V or a negative DC voltage of several to several tens volts. The anode electrode 38 receives a voltage needed for accelerating the electron beams, for example, a positive DC voltage of several hundreds to several thousands volts.

Electric fields are then formed around the electron emission regions 28 due to the voltage difference between the cathode and the gate electrodes 22, 24, and electrons are emitted from electron emission regions 28. The emitted electrons pass through the opening portions of the focusing electrode 30, followed by being focused at the centers of the bundles of electron beams, and are attracted by the high voltage applied to the anode electrode 38, thereby colliding against the phosphor layers 34 and exciting the phosphor layers to emit light.

In the present embodiment, the anti-static layer related to the first embodiment or the anti-static layer related to the second embodiment is formed at the internal non-active area of the vacuum vessel.

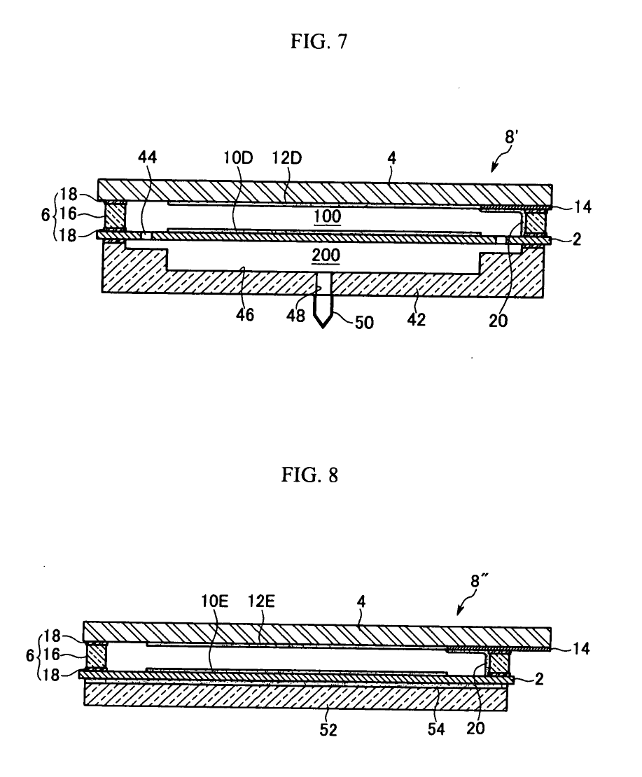

As explained above, spacers 40 are arranged between the first and the second substrates 2, 4 to space them apart from each other at a predetermined distance. Alternatively, a stable vacuum vessel may be obtained without mounting the spacers between the first and the second substrates 2, 4. An image display device having such a vacuum vessel according to a third embodiment of the present invention will be now explained with reference to FIG. 7.

As shown in FIG. 7, the vacuum vessel 8′ includes first and second substrates 2, 4 facing each other by interposing a first region 100 and attached to each other by using a sealing member 6, and a reinforcing member 42 attached to the rear of the first substrate 2 to form a second region 200 together with the first substrate 2. The first and the second regions 100, 200 refer to the spaces divided by the first substrate 2. Through-holes 44 are formed at the first substrate 2 such that the first and the second areas 100, 200 communicate with each other therethrough.

An electron emission unit 10D is provided on a surface of the first substrate 2 facing the second substrate 4, and a light emission unit 12D and anode leads 14 are formed on a surface of the second substrate 4 facing the first substrate 2. An anti-static layer 20 covers the portion of the anode lead 14 placed internal to the sealing member 6, the boundary between the anode lead 14 and the inner wall of the sealing member 6, and a part of the inner wall of the sealing member 6.

The second substrate 4 in an exemplary embodiment is formed having a thickness large enough to endure the vacuum pressure, for example, of a thickness of 10 mm or more. In contrast, since the vacuum pressure is not applied to the first substrate 2, the first substrate 2 may be formed having a thickness smaller than that of the second substrate 4, for example, with a thickness of 5 mm or less.

As described above, the first substrate 2 is a substrate with electron emission regions, and various kinds of electrodes for controlling the on/off and amount of electron emission from the electron emission regions, and the trajectories of electron beams. A high temperature thermal treatment is made several times during the process of forming electron emission regions, electrodes and inter-electrodes insulating layers. In this process, the first substrate 2 with a thickness of 5 mm or less has a low thermal stress even under the radical temperature variation so that it is prevented from being broken, and the layer formation characteristic of the electron emission unit 10D is enhanced.

The reinforcing member 42 outlines the vacuum vessel 8′ instead of the first substrate 2, and internally has a concave portion 46 to form a second region 200 surrounded by the first substrate 2 and the reinforcing member 42. The second region 200 is established to bear a volume larger than that of the first region 100. The reinforcing member 42 has an exhaust vent 48 and an exhaust tube 50 for exhausting the interior of the structure, and a getter (not shown) for absorbing the remnant gas after the exhausting to heighten the vacuum degree.

The internal volume of the vacuum vessel 8′ is enlarged by forming the first and the second regions 100, 200 so that the distance between the first and the second substrates 2, 4 is kept constant without mounting spacers at the first region 100, thereby securing a stabilized structure. With the enlargement of the internal volume of the vacuum vessel 8′, the initial vacuum degree is heightened to be about 10⁻⁶ Torr or more, and the deterioration of the vacuum degree due to the outgassing during the product usage is compensated for, thereby providing excellent product characteristics.

Further, a reinforcing substrate may be provided at the rear of the first substrate 2 instead of the above-described reinforcing member 42. FIG. 8 is a cross sectional view of an image display device according to a fourth embodiment of the present invention. As shown in FIG. 8, a reinforcing substrate 52 is attached to the rear of the first substrate 2 such that the first substrate 2, the second substrate 4 and the reinforcing substrate 52 form vacuum vessel 8″.

The reinforcing substrate 52 has a thickness larger than that of the first substrate 2. After the steps of forming the layers for the electron emission unit 10E on the first substrate 2 are all conducted, the reinforcing substrate 52 is attached to the rear of the first substrate 2 by using an adhesive layer 54. In order to endure the vacuum pressure, the thickness of the reinforcing substrate 52 may be wholly 10mm or more, and in an exemplary embodiment, 15 mm or more. As shown in FIG. 8, the reference numeral 12E indicates a light emission unit.

Even with the image display devices according to the third and the fourth embodiments, the anti-static layer related to the first embodiment or the second embodiment is formed at the internal non-active area of the vacuum vessel. FIGS. 7 and 8 conveniently show a case where the anti-static layer 20 related to the first embodiment is formed within the vacuum vessel 8′, 8″.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. An image display device comprising:
a vacuum vessel having a first substrate and a second substrate facing each other, and a sealing member disposed between the first substrate and the second substrate, the vacuum vessel having an active area internal to the sealing member, and a non-active area surrounding the active area internal to the sealing member;
an electron emission unit provided at an active area of the first substrate;
a light emission unit provided at an active area of the second substrate to emit visible rays resulting from electrons emitted from the electron emission unit; and
an anti-static layer provided on at least a part of the non-active surface area.

2. The image display device of claim 1, further comprising anode leads drawn from the light emission unit to one-side of a periphery of the second substrate and extending over an inside of the sealing member and an outside of the sealing member, wherein the anti-static layer covers a boundary area between the anode lead and an inner wall of the sealing member.

3. The image display device of claim 2, wherein the anti-static layer is in the shape of a band having a predetermined width, and covers a surface portion of an anode lead internal to the sealing member around the boundary area, and a part of the inner wall of the sealing member.

4. The image display device of claim 3, wherein the anti-static layer has a width larger than a width of the anode lead.

5. The image display device of claim 3, wherein anode leads are provided in pairs at the one-side of periphery of the second substrate, and anti-static layers are provided in pairs corresponding to the anode leads.

6. The image display device of claim 2, wherein the anti-static layer is formed on an entire non-active surface area of the first substrate, the entire non-active surface area of the second substrate including the anode lead and an entire inner wall of the sealing member.

7. The image display device of claim 1, wherein the anti-static layer is formed of a material having a secondary electron emission coefficient of about 1.

8. The image display device of claim 7, wherein the anti-static layer is formed of chromium oxide Cr₂O₃.

9. The image display device of claim 7, wherein the anti-static layer is formed of metallic oxide based on a metallic material selected from the group consisting of Cr, Mn, Fe, Co, Y, Ni, Cu, Zr, Nb, Mo, Hf, Ta, W, and Ru, or a combination thereof.

10. The image display device of claim 1, wherein the vacuum vessel further comprises a reinforcing member provided at a rear of the first substrate forming an internal space together with the first substrate, and the first substrate comprises at least one through-hole within the vacuum vessel.

11. The image display device of claim 1, wherein the vacuum vessel further comprises a reinforcing substrate attached to a rear of the first substrate and having a thickness larger than a thickness of the first substrate.

12. The image display device of claim 1, wherein the electron emission unit includes electron emission regions having cold cathode electron sources.

13. The image display device of claim 1, wherein the electron emission unit includes cathode electrodes and gate electrodes separated from each other by an insulating layer, and having electron emission regions electrically connected to the cathode electrodes.

14. The image display device of claim 13, further comprising a focusing electrode located over the cathode electrodes and the gate electrodes, the focusing electrode being insulated from the cathode electrodes and the gate electrodes.

15. A method of preventing arc discharge in an image display device, the image display device having a vacuum vessel formed by a pair of substrates facing each other and a sealing member provided at peripheries of the pair of substrates, the vacuum vessel including a light emission unit having an anode electrode and anode leads for applying a voltage to the anode electrode, the anode leads being drawn from the light emission unit to a periphery of the substrates and extending over an internal non-active area of the sealing member and an outside of the sealing member, the method comprising:
forming an anti-static layer at the internal non-active area of the vacuum vessel, the anti-static layer covering at least the inner wall of the sealing member and the anode leads within the vacuum vessel.
